(19) United States
(12) Patent Application Publication
(10) Pub. No.: US 2024/0412166 A1
(43) Pub. Date: Dec. 12, 2024

(54) SYSTEM AND METHOD FOR ASSESSING AND PLANNING A PROJECT

(71) Applicant: KPMG LLP, New York, NY (US)

(72) Inventors: Clay GILGE, Seattle, WA (US); Colin CAGNEY, Phoenix, AZ (US); Kevin MAX, New York, NY (US); Lienna TIEH, Houston, TX (US); Ken WIEGAND, Seattle, WA (US)

(21) Appl. No.: 18/736,202

(22) Filed: Jun. 6, 2024

Related U.S. Application Data
(60) Provisional application No. 63/506,492, filed on Jun. 6, 2023.

(51) Int. Cl. G06Q 10/10; G06Q 10/0631; G06Q 10/0635

(52) U.S. Cl. CPC G06Q 10/103; G06Q 10/063114; G06Q 10/06313; G06Q 10/0635

(57) ABSTRACT

A computer-implemented system for assessing a project comprising a project readiness assessment unit for assessing a project readiness of a project based on project data and for generating a project assessment score. The system can include a project diagnostic assessment unit for receiving project cost data and for determining an accuracy of a cost associated with the project based on the project cost data and for generating a project cost accuracy score. A project schedule assessment unit can be employed for applying one or more schedule analysis and assessment techniques to the project schedule data to assess a quality and an accuracy of a project schedule and for generating a project schedule score. A project risk assessment unit can process project risk data for determining an inherent risk score associated with the project. A project control assessment unit can process project control data for generating a project control score.

### RELATED APPLICATION

The present application claims priority to U.S. provisional patent application Ser. No. 63/506,492, filed on Jun. 6, 2023, and entitled System and Method For Assessing and Planning a Project, the contents of which are herein incorporated by reference.

### BACKGROUND OF THE INVENTION

The present invention is related to project planning tools and techniques, and is more specifically related to a project management tool that allows a user to oversee the entirety of a project.

A traditional technique for planning and monitoring a project employs the use of a project management framework, such as the Project Management Body of Knowledge (PMBOK) or Agile. These conventional frameworks provide a structured approach for organizing and executing projects. The creation and execution of a project can include a series of project related steps. The project related steps can include project initiation, project planning, project execution, project monitoring and control, and project closure. The project initiation step can help define the project scope, objectives, and stakeholders, as well as identify potential project related risks and constraints. The project planning step can include developing a comprehensive project plan that outlines the project goals, deliverables, timelines, resources, and budget. The project execution step can help the stakeholder implement the project plan and manage a project team and resources to ensure that the project is progressing according to the project plan. The project monitoring and control step can involve tracking progress of a project, identifying any deviations from the project plan, and recommending corrective actions to the user or stakeholder to get the project back on track. The project closure step can involve finalizing and completing the project, including delivering the final product or service and completing any remaining tasks.

Throughout the project lifecycle, various tools and techniques can be used to monitor progress of the project and to ensure that the project stays on track. These conventional tools include status reports, project schedules, project dashboards, risk management plans, and stakeholder communication plans, and the like. By regularly reviewing and updating these tools, project managers can stay informed about the project status, identify potential issues, and take proactive measures to keep the project moving forward. While conventional project planning techniques can be occasionally effective, these conventional tools suffer from drawbacks that can limit their effectiveness. The drawbacks can include a lack of project flexibility since conventional project planning techniques are often rigid and inflexible, with detailed plans developed upfront that can be difficult to modify as circumstances change. The inherent inflexibility in these conventional systems and tools can lead to project delays and cost overruns. Another drawback of conventional project planning tools is that the tools place an overemphasis on project planning at the expense of project action. Specifically, project teams can become overly focused on developing the project plan and provide insufficient time and resources to reasonably executing the project plan. The conventional project plans are also, oftentimes, based on assumptions and estimates, which can make it difficult to predict project outcomes with reasonable levels of accuracy. As such, conventional project planning tools can lead to project surprises and unexpected project challenges, and struggle to handle project uncertainty, particularly in complex or dynamic project environments. This can lead to a lack of adequate contingency planning and an inability to adapt to externally changing circumstances.

### SUMMARY OF THE INVENTION

The project planning and assessment system of the present invention can be configured to evaluate a project at any point in the project lifecycle and to provide targeted and objective benchmarking to industry peer groups and performance improvement actions specific to the project phase and technical project details. The system of the present invention can be configured to also evaluate the human element of project performance by assessing non-technical soft controls such as leadership, tone, culture, accountability for outcomes, team skills and processes for disagreement and raising concerns.

The present invention is directed to a computer-implemented system for assessing a project, comprising a project readiness assessment unit for assessing a project readiness of a project based on source data from a plurality of data sources and for generating a project assessment score, wherein the source data includes project data and wherein the project data includes project cost data including project cost estimate data, project scope data, project risk data, and project control data; a project diagnostic and cost assessment unit for receiving the project cost data including the project cost estimate data and for determining an accuracy of a cost associated with the project based on the project cost data and the project cost estimate data and for generating a project cost accuracy score; a project schedule assessment unit for applying one or more schedule analysis and assessment techniques to the project schedule data to assess a quality and an accuracy of a project schedule and for generating a project schedule score; a project risk assessment unit for processing the project risk data and for determining an inherent risk score associated with the project; a project control assessment unit for receiving and processing the project control data and for generating a project control score; and a reporting unit that can includes a user interface generator for generating one or more user interfaces for generating and displaying on a display device one or more reports.

The project readiness assessment unit comprises a categorization unit for categorizing the source data into a plurality of project categories, wherein each of the plurality of project categories includes a plurality of project subcategories, wherein the categorization unit generates category data, and a project readiness scoring unit for receiving and processing the category data and for generating the project assessment score. The project readiness scoring unit generates the project assessment score by summing together a category assessment score generated for each of the plurality of project categories, and each of the category assessment scores are determined by summing together a subcategory assessment score for each of the plurality of project subcategories associated with each of the plurality of project categories, and the project assessment score is indicative of a readiness of the project to be undertaken. According to one embodiment, the plurality of project categories can include one or more of a project characteristics category, a project execution strategy category, a basis of design category, and an operations category. Further, the project characteristics category can include a plurality of project subcategories including two or more of a project objective subcategory, a due diligence subcategory, a funding model subcategory, a schedule definition subcategory, and a development rights subcategory. Optionally, the category scores for each of the plurality of project categories or the subcategory scores for each of the plurality of project subcategories can be weighted relative to each other based on one or more project factors. For example, the project assessment score associated with each of the plurality of project categories can be compared with a corresponding threshold assessment score, and if the project assessment score is less than the threshold assessment score, perform one or more project related actions. The one or more project related actions can include one or more of delaying or holding the project, recommend that additional project design work be performed to reduce uncertainty associated with the project, correct any identified project scheduling issues, adjust a budget associated with the project, and recommend the addition of one or more project resources. Further optionally, the project data can include stage data and gate data, and wherein the project readiness assessment unit can process the stage data and the gate data to determine a progress of the project.

According to another embodiment, the project diagnostic and cost assessment unit can include a cost classification unit for classifying the project cost data into one or more of a plurality of cost classifications, where each of the plurality of cost classifications includes a plurality of cost subclassifications, wherein the cost classification unit generates cost classification data, and a project cost accuracy determination unit for determining, based on the cost classification data, a project cost accuracy score indicative of an accuracy of a cost associated with the project. The plurality of cost classifications can include a process industry cost classification and a general building cost classification. The cost accuracy determination unit can optionally generate the project cost accuracy score by summing together a classification score generated for each of the plurality of cost classifications, and wherein the classification scores are determined by summing together a subclassification score for each of the plurality of cost subclassifications associated with each of the plurality of classifications. The cost accuracy determination unit can optionally generate the project cost accuracy score by employing one or more project cost measurement techniques, which includes one or more of a percentage deviation technique, a root mean square error (RMSE) technique, a mean absolute error (MAE) technique, and a standard deviation technique.

Further optionally, the project cost accuracy determination unit can generate the project cost accuracy score by employing one or more project cost comparative analysis techniques. The project cost comparative analysis techniques can include one or more of an analogous estimation technique, a bottom-up estimation technique, a three-point estimation technique, a parametric estimation technique, an expert judgment estimation technique, and a reserve analysis estimation technique.

According to another embodiment of the invention, the project schedule assessment unit can include a project schedule assessment unit for applying one or more schedule analysis and assessment techniques to the project schedule data to assess the quality and the accuracy of the project schedule and for generating project schedule assessment data, and a project schedule scoring unit for determining the project schedule score based on one or more of the project schedule assessment data and a third party project schedule score. The schedule analysis and assessment technique analyzes the project schedule data and evaluates the quality and the accuracy of the project schedule data based on a set of predetermined project criteria. The project criteria can include two or more of a project logic criteria, project lead criteria, project lag criteria, project relationship criteria, project hard restraint criteria, high float criteria, a negative float criteria, high duration task, invalid dates criteria, resources criteria, missed tasks criteria, critical path test criteria, a critical path length index (CPLI) criteria, and a baseline execution index (BEI).

The project schedule scoring unit can determine a project score for each of the predetermined project criteria, and the project schedule scoring unit determines a total project schedule score by summing together the project scores associated with each of the project criteria. Optionally, each of the project scores associated with each of the project criteria can be weighted differently relative to each other based on one or more predetermined project weighting factors.

According to a further embodiment, the project risk assessment unit can include a risk categorization unit for categorizing the project risk data into a plurality of project risk categories, wherein each of the plurality of project risk categories includes a plurality of project risk subcategories, wherein the categorization unit generates risk category data, and a risk scoring unit for receiving and processing the risk category data and for generating the inherent risk score. The risk scoring unit can optionally determine the inherent risk score by summing together a category risk score generated for each of the plurality of project risk categories, and wherein the category risk scores are determined by summing together a subcategory risk score for each of the plurality of project risk subcategories associated with each of the plurality of project risk categories, and wherein the inherent risk score is determined by summing together the category risk scores. The risk scoring unit can optionally compare one or more of the category risk score, the subcategory risk score, or the inherent risk score with a threshold risk score, and if the risk score is above the threshold risk score, then the project risk assessment unit recommends a project risk action.

According to still another embodiment, the project control assessment unit can include a control categorization unit for categorizing the project control data into a plurality of project control categories, wherein each of the plurality of project control categories includes a plurality of project control subcategories, wherein the control categorization unit generates control category data, and a control scoring unit for receiving and processing the control category data and for generating the project control score. Optionally, each of the plurality of project control subcategories has a plurality of assessment queries associated therewith,

The present invention can also be directed to a computer-implemented method for assessing a project comprising assessing a project readiness with a project readiness assessment unit based on source data from a plurality of data sources and for generating a project assessment score, wherein the source data includes project data and wherein the project data includes project cost data including project cost estimate data, project scope data, project risk data, and project control data; determining an accuracy of a cost associated with the project with a project diagnostic and cost assessment unit based on the project cost data and the project cost estimate data and generating in response a project cost accuracy score; applying one or more schedule analysis and assessment techniques to the project schedule data with a project schedule assessment unit for assessing a quality of a project schedule and an accuracy of the project schedule and for generating a project schedule score; determining an inherent risk score associated with the project with a project risk assessment unit based on the project risk data; and assessing one or more project controls associated with the project with a project control assessment unit based on project control data and in response generating a project control score.

According to one method of the present invention, the step of assessing a project comprises categorizing the source data into a plurality of project categories, wherein each of the plurality of project categories includes a plurality of project subcategories and generating category data, and generating the project assessment score based on the category data. The step of generating the project assessment score can include summing together a category assessment score generated for each of the plurality of project categories, and wherein the category assessment scores are determined by summing together a subcategory assessment score for each of the plurality of project subcategories. Optionally, the category assessment scores for each of the plurality of project categories or the subcategory assessment scores for each of the plurality of project subcategories can be weighted relative to each other based on one or more project factors. Further, the project assessment score associated with each of the plurality of project categories can optionally be compared with a corresponding threshold assessment score, and if the project assessment score is less than the threshold assessment score, perform one or more project related actions.

According to another method of the present invention, the step of determining the accuracy of the cost associated with the project can include classifying the project cost data into a plurality of cost classifications, wherein each of the plurality of cost classifications includes a plurality of cost subclassifications, and then generating cost classification data, and determining the accuracy of the cost associated with the project based on the cost classification data and generating in response the project cost accuracy score. The project cost accuracy score can be optionally determined by summing together a classification cost score generated for each of the plurality of cost classifications, wherein the classification cost scores are determined by summing together a subclassification cost score for each of the plurality of cost subclassifications associated with each of the plurality of cost classifications. Further optionally, the method can include generating the project cost accuracy score by applying one or more project cost measurement techniques to the cost classification data. The project cost measurement techniques can include one or more of a percentage deviation technique, a root mean square error (RMSE) technique, a mean absolute error (MAE) technique, and a standard deviation technique.

According to another embodiment, the step of assessing a quality of a project schedule can include applying the one or more schedule analysis and assessment techniques to the project schedule data and assessing the quality and the accuracy of the project schedule and generating project schedule assessment data, and determining the project schedule score based on one or more of the project schedule assessment data and a third-party project schedule score. The schedule analysis and assessment technique can analyze the project schedule data and can evaluate the quality and the accuracy of the project schedule data based on a set of predetermined project criteria. The project criteria can include one or more of, or two or more of, a project logic criteria, project lead criteria, project lag criteria, project relationship criteria, project hard restraint criteria, high float criteria, a negative float criteria, high duration task, invalid dates criteria, resources criteria, missed tasks criteria, critical path test criteria, a critical path length index (CPLI) criteria, and a baseline execution index (BEI). The method can also include determining a project score for each of the predetermined project criteria, and determining the project schedule score by summing together the project scores associated with each of the project criteria.

According to still another embodiment of the present invention, the method includes categorizing the project risk data into a plurality of project risk categories, wherein each of the plurality of project risk categories includes a plurality of project risk subcategories, and generating risk category data, and receiving and processing the risk category data and generating the inherent risk score based thereon. The method can include determining the inherent risk score by optionally summing together a category risk score generated for each of the plurality of project risk categories, wherein the category risk scores are determined by summing together a subcategory risk score for each of the plurality of project risk subcategories associated with each of the plurality of project risk categories, and then determining the inherent risk score by summing together the category risk scores.

The method of the present invention can also include categorizing the project control data into a plurality of project control categories, wherein each of the plurality of project control categories includes a plurality of project control subcategories, and generating control category data, and receiving and processing the control category data and generating the project control score. Further, each of the plurality of project control subcategories has a plurality of assessment queries associated therewith.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of a project planning and assessment system according to the teachings of the present invention.

FIG. 2 is a schematic block diagram of the project readiness assessment unit of the project planning and assessment system of FIG. 1 according to the teachings of the present invention.

FIG. 3 is a schematic block diagram of the project diagnostic and cost assessment unit of the project planning and assessment system of FIG. 1 according to the teachings of the present invention.

FIG. 4 is a schematic block diagram of a project schedule assessment unit of the project planning and assessment system of FIG. 1 according to the teachings of the present invention.

FIG. 5 is a schematic block diagram of a project risk assessment unit of the project planning and assessment system of FIG. 1 according to the teachings of the present invention.

FIG. 6 is a schematic block diagram of a project control assessment unit of the project planning and assessment system of FIG. 1 according to the teachings of the present invention.

FIG. 7 is a schematic block diagram of an ESG assessment unit of the project planning and assessment system of FIG. 1 according to the teachings of the present invention.

### DETAILED DESCRIPTION OF THE INVENTION

As used herein, the term “source data” can include any type of data from any suitable data source that would benefit from being converted into a more usable form or is intended to be processed by the project planning and assessment system of the present invention. The source data can include, for example, project related data, financial data, and the like. The project related data can include project scope data, project cost data. project schedule data, project risk data, and project control data. The source data can be in hard copy or written form, such as in printed documents, or can be in digital file formats, such as in portable document format (PDFs), word processing file formats such as WORD documents, spreadsheet file formats such as EXCEL documents, as well as other file formats including hypertext markup language (HTML) and extensible markup language (XML) file formats and the like. It is well known in the art that the hard copies can be digitized and the relevant data extracted therefrom. The data can also be harmonized prior to processing by the system. For example, the source data can be converted into a PDF format for subsequent processing.

As used herein, the term “project related data” or “project data” is intended to mean or include or refer to any information, documentation, plans, or records related to a specific project. The project data can include details, such as project plans, project timelines, project schedules, project budget, resources, team members or stakeholders, goals, objectives, risk data, project control data, and other relevant information. More specifically, the project data can include project scope data, project cost data including project cost estimate data, project schedule data, project risk data, project control data, project management data, Environmental, Social and Governance (ESG) data, technical data, stakeholder data, project participant data, financial data, performance data, project stage data, gate data, and legal and regulatory related data, as well as other types of related data. The project management data can include information about the project plan, timeline, budget, resources, and performance metrics. The project management data can be used to monitor project progress and enables the user to make informed decisions about management of the project. The technical data can include data related to the design, development, testing, and implementation of the project or project plan. The technical data helps ensure that the project meets technical requirements and quality standards. The stakeholder data can include information about project stakeholders, project related needs, interests, and expectations. The stakeholder data helps the user manage stakeholder relationships and ensuring that the project meets stakeholder requirements. The project risk data can include information related to or about potential risks and the likelihood and impact on the project or project plan. The project risk data can help the user identify and mitigate project risks while ensuring that the project is consistent with a predetermined project timeline. The performance data can include data related to project performance, such as progress reports, quality metrics, and stakeholder feedback. The performance data can be employed to monitor project performance and identify opportunities for project improvement. The legal and regulatory data can include information about legal and regulatory requirements that impact the project, such as contracts, permits, and compliance obligations. The legal and regulatory data can help ensure that the project meets legal and regulatory requirements. Further, the project plan data can include site plans, demolition plans, electrical and mechanical plans, and other related site-specific information. The data can be generated through various methodologies, such as meetings, reports, surveys, documentation, or any other data collection or data aggregation method used to monitor, track and manage the progress of a project. The data enables the system of the present invention, as well as project managers and team members, to make informed decisions based on the project data and to ensure successful project completion.

As used herein, the term “financial data” or “financial related data” is intended to include any source data that is associated with or contains financial or financial related information. The data can include information related to project costs, including budget estimates, actual expenses, and financial reports. The financial information can include information that is presented in free form, in tabular format, or in a financial report, and is related to data associated with business, financial, monetary, tax, or pecuniary interests. The financial information can also include operational data that is associated with the processing of the financial data by the system. The operational data can include for example engineering data, manufacturing process data, and the like. Further, the financial data can have a deliverables portion, where the deliverables are associated with the analysis or preparation of financial reports or reports displaying the data associated with the deliverable.

As used herein, the term “project scope” or “scope” is intended to include, mean or refer to the defined boundaries and parameters of a project, and can outline the specific deliverables, tasks, and objectives that the project aims to achieve within a given timeline, budget, and resources. The project scope defines what is and what is not included in the project and provides an understanding of the project's goals and objectives. The project scope can include a statement of work (SOW) that outlines the project's purpose, objectives, stakeholders, and success criteria. The project scope may also include a project plan, which outlines the tasks, timelines, milestones, and resources required to achieve the project's objectives. The project scope can also include any constraints or assumptions that impacts the project's execution or outcome.

As used herein, the term “project” is intended to include, mean or refer to an endeavor that is designed to achieve a specific goal or objective within a defined timeframe and budget. The project can involve a series of coordinated and interrelated activities or tasks that are executed by a team of people with defined roles and responsibilities. Projects are distinguished from routine operations, activities or endeavors in that they are temporary-meaning they have a defined beginning and end, and they are unique in their goals and objectives. Projects are often complex and involve multiple phases, requiring careful planning, execution, and control to ensure the success of the project. Examples of projects can include developing a new product, constructing a building, facility or plant, implementing a new software system, or organizing a large event. Projects can range in size and complexity, from small, straightforward endeavors to large, complex initiatives that require significant resources and coordination.

As used herein, the term “enterprise” is intended to include a structure, facility, business, company, operation, organization, or entity of any size. Further, the term is intended to include an individual or group of individuals, or a device of any type.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “machine learning” is intended to mean the application of one or more software application techniques or models that process and analyze data to draw inferences and/or predictions from patterns in the data. The machine learning techniques can include a variety of models or algorithms, including supervised learning techniques, unsupervised learning techniques, reinforcement learning techniques, knowledge-based learning techniques, natural-language-based learning techniques such as natural language generation, natural language processing (NLP) and named entity recognition (NER), deep learning techniques, and the like. The machine learning techniques are trained using training data. The training data is used to modify and fine-tune any weights associated with the machine learning models, as well as record ground truth for where correct answers can be found within the data. As such, the better the training data, the more accurate and effective the machine learning model.

The project planning and assessment system of the present invention is intended to receive and process project related data so as to enable users of the project planning and assessment system to monitor, track and assess the relevant aspects of a project. The project planning and assessment system can serve as a project planning and assessment tool to allow the user to easily and efficiently assess project readiness, project budget and development maturity, schedule quality, risk management and associated risks, and the maturity of the project management process and associated controls.

The project planning and assessment system allows the users to gain meaningful insights into the current status of a project and any associated key deliverables. The system also allows the users to be able to track project performance through a project lifecycle and help the user identify actionable and specific steps that can be undertaken to improve project performance. The project planning and assessment system can be employed to generate various types of project related scores associated with different aspects of the project. The project related scores can be a total or aggregate score, can be scores associated with various categories or subcategories, can be scores that are constructed as predefined tiers, and the like. The project related scores can be optionally compared to threshold scores in order to determine whether selected follow-up action is required.

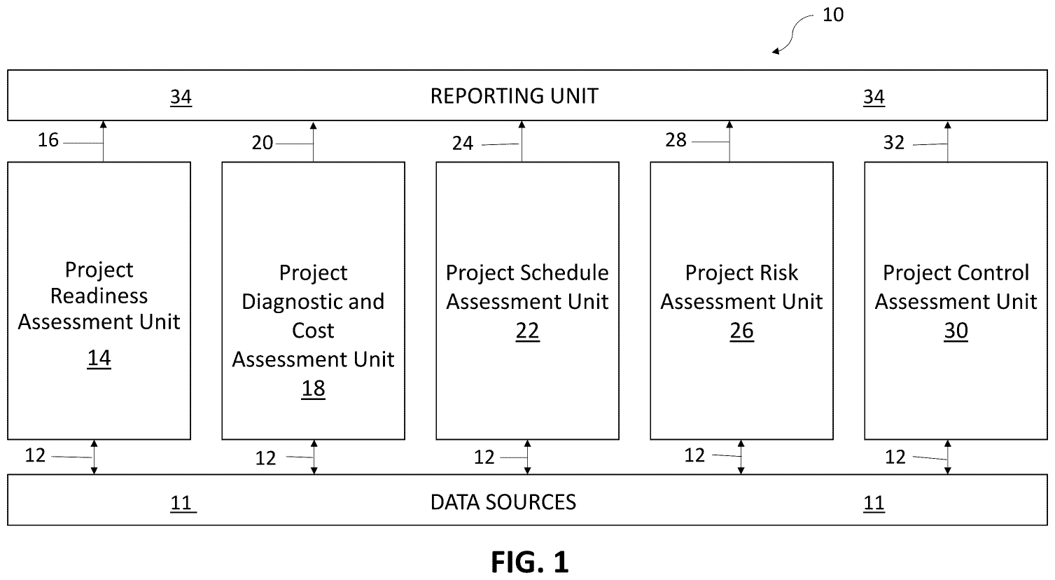

One embodiment of the project planning and assessment system according to the teachings of the present invention is shown in FIG. 1. The illustrated project planning and assessment system 10 can be configured to receive source data 12, which can include project data, including for example project scope data, project cost data, project schedule data, project risk data, project control data, as well as other types of data including financial data, from a plurality of different data sources 11, and then process the source data 12 to assess the overall project scope and readiness of the project (e.g., project readiness). As used herein, the term “project readiness” or “readiness of a project” is intended to include or mean a general state of preparedness of a project to be initiated or executed successfully by ensuring that all necessary resources, including personnel, funding, materials, and equipment, are available and in place. Additionally, project readiness also encompasses the identification and mitigation of potential risks and obstacles that can impede the project's progress or success. Achieving project readiness may require an assessment of the project's goals, objectives, timeline, budget, and project scope, as well as a clear understanding of the roles and responsibilities of all involved stakeholders. The overall readiness of the project can be determined and conveyed in any selected manner, and according to one embodiment, the overall project readiness can be determined by employing a project readiness score.

The source data 12 can be captured, aggregated or generated using a number of different data collection techniques, including through interviews, questionnaires, reports, meetings, surveys, documentation, project scope related documents and information, or any other types of data collection or data aggregation techniques. For example, one or more project participants can prepare an initial document request list identifying the documents, including project scope related information, needed from the client or stakeholder prior to scheduling project related interviews. The information accumulated as part of this data collection process can form part of the source data 12 from the data sources 11 that is then input into the project readiness assessment unit 14. The project related interviews can include interviews with key project participants who have an understanding or familiarity with the design, operating effectiveness, monitoring and compliance of various aspects of the project, as well as with the client or stakeholder. The project participants can include business managers, business executives, project managers and engineers, procurement managers, construction managers, risk managers, accounting and financial personnel, and the like. The source data 12, which can include project scope and project readiness data and other project related type data, can be transferred or conveyed from the data sources 11 to the project readiness assessment unit 14 for processing the source data 12 and generating project assessment data 16 based thereon. The project readiness assessment unit 14 can process the source data 12 so as to assess a readiness of a project based on the source data.

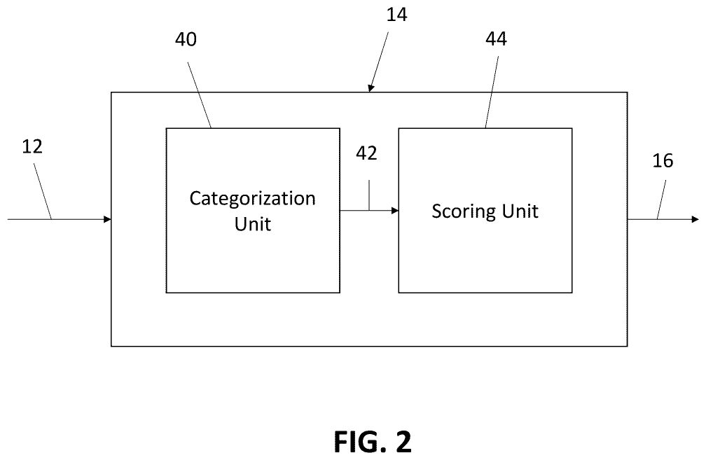

As shown in FIG. 2, the illustrated project readiness assessment unit 14 can include a categorization unit 40 suitable for automatically categorizing the source data 12 into a series of project related categories. Each of the project related categories can include a series of project related subcategories. The project related categories can include, by simple way of example, two or more of a project characteristics category, a project execution strategy category, a basis of design category, and an operations category. Each of the categories can include a series of project related subcategories. For example, the project characteristics category can include one or more of or two or more of a project objective subcategory, a due diligence subcategory, a funding model subcategory, a schedule definition subcategory, and a development rights subcategory. The project execution strategy category can include one or more of (or two or more of; or three of more of) the project execution subcategories that includes a project management subcategory, a project administration subcategory, a procurement strategy subcategory, a design management subcategory, and a risk and contingency management subcategory. The subcategories can include functional elements and tasks that enable successful execution of the project strategy and overall project objectives. The project management subcategory can include or is related to relationships and coordination with other projects, the specific project manager, roles and responsibilities of the stakeholders, project staffing requirements, project staffing plan, and work breakdown structure (WBS) completeness and integration. The project administration subcategory can include or are related to project questions, project safety, project reporting, project document reporting and management, and site utilization information. The procurement strategy subcategory can include or is related to the procurement plan and other core procurement activities including the procurement plan, the project contracting methodology, the project bidding and tendering plan, the procurement plan, project contract information, project contract development, project procurement requirements, and project materials and equipment. The design management subcategory includes managing design milestones, requirements and value engineering in coordination with other project management and planning activities. This subcategory can hence be related to or include project design management milestones, value engineering, and project design review requirements. The risk and contingency management subcategory can include early risk identification and mitigation as well as contingency planning by project planning before transition to the risk management or project controls portion of the project. This subcategory can include or is related to project risk identification information, project risk mitigation information, and project contingency planning related information.

The basis of design category is related to the foundation design elements that ensure that the project scope and initial project assumptions and site conditions and requirements are fully vetted and integrated. The basis of design category can include or is related to one or more of (or two or more of; or three of more of) design subcategories that include a site requirement subcategory, a design requirement subcategory, and a drawing definition subcategory. The site requirement subcategory includes proper investigation and due diligence of existing site and scope conditions, as well as a demolition and site remediation plan to ensure that the site is ready and prepared for construction activities. The design subcategory can include or is related to existing conditions, and demolition plans. The design requirement subcategory includes the documentation and gathering of design scope including intent, equipment, utilities and operations and maintenance requirements. This subcategory includes or is related to design intent, mechanical and equipment, utility impact, project operations and maintenance requirements, project support and structural design information, ancillary buildings, and project design flexibility. The drawing definition subcategory includes the approach, guidelines and methodology for developing project design documents, engineering drawings and the process for developing the design documents throughout the project planning, design and construction phases. The drawing definition subcategory includes or is related to project schematic layouts, civil engineering information, design development information, and construction drawings and model information.

The operations category includes the activities and required deliverables and steps for commissioning, starting, and handing over the operations of the project. The operations category includes one or more operations subcategories including a commissioning plan subcategory, an operations readiness subcategory, and a development and execution subcategory. The commissioning plan subcategory includes or is related to early project commissioning activities, commissioning plan information, and project turnover sequence information. The operational readiness subcategory includes activities and integration/coordination with operations stakeholders. This subcategory is related to or includes supply chain transition information, asset integration information, operator recruitment and training information, and project contract information including lease up/offtake contract information. The development and execution subcategory includes operational planning for the facility as well as operational performance plan for ensuring the facility meets performance/availability requirements. This subcategory can include or is related to operational planning and performance evaluation.

The source data 12 can be categorized according to the foregoing categories and subcategories. Those of ordinary skill in the art will readily recognize, based on the teachings herein, that any selected type or number of categories and subcategories can be employed by the categorization unit 40. The categorization unit 40 can generate category data 42 that is received by a scoring unit 44. The scoring unit 44 can be configured to automatically process the category data 42 and generate the project assessment data 16 that can include a project assessment or readiness score that can be associated with any number of categories and subcategories, and/or with each category and/or subcategory, or with any combination thereof. The scoring unit 44 can also generate a total or aggregate project assessment score for one or more of or for each category based on the cumulative scores of each subcategory, as well as a total or aggregate project assessment or readiness score for the entire project based on a summation of the assessment scores associated with each category and/or subcategory. The assessment scores for each category or subcategory can be weighted relative to each other based on known project factors, such as business drivers (e.g., project budget, project quality, project schedule, project risk, and safety), corporate or regulatory mandates, previous project based assessments or audits, project status, phase of the project, and the like. The project assessment scores generated by the scoring unit 44 are essentially project related scores and can be normalized in any selected or preferred manner. The scoring unit 44 can also compare the project scores generated for each project category or project subcategory with a threshold project assessment score indicative of a general readiness factor associated with the category or subcategory. In response to the comparison to the threshold score, the scoring unit 44 can perform one or more selected project related actions, such as delaying or holding the project to address any selected issues, recommend that additional design work be performed to reduce project uncertainty, selectively address and fix any associated project scheduling issues, adjust or modify the project budget, recommend the addition of resources, and the like. The project assessment scoring data forming part of the project assessment data 16 generated by the scoring unit 44 can be indicative of an assessment of the viability or readiness of the project to be undertaken, as well as being indicative of the likelihood of success, execution strategy, and design of the project based on known factors. The scoring unit 44 can optionally employ selected industry standards forming part of a maturity model, as well as custom information, that are stored in the project readiness assessment unit 14 when generating the project assessment scores associated with each project category and project subcategory. The maturity model is essentially a structured framework that can be used to assess an effectiveness, efficiency, and sophistication of the processes, systems, or capabilities of the project in a specific domain or area. The model provides a roadmap for improvement by defining a progression of maturity levels or tiers, each representing a higher state of development and optimization. Each level or tier can have specific criteria associated therewith that defines what must be achieved to be considered at that level. As such, the project assessment scores can be based on any selected type of tiered scale, where an example of a suitable scale is a scale of 1-4, as defined by the standards. The industry standards employed by the scoring unit 44 can include the Construction Industry Institute Project Definition Rating Index, the standards published by the Construction Industry Institute (CII), the standards associated with the Association for the Advancement of Cost Engineering International (AACE International), the Defense Contract Management Agency (DCMA) standards, and the like. For example, the industry standards can include the Construction Industry Institute (CII) Project Definition Rating Index (PDRI) that employs quantitative elements and a tiered scoring or rating system. The CIIPDRI is a tool that can be used to measure the completeness and quality of the project definition during the project assessment phase. The standard can employ any selected type of scoring system, an example of which is a tiered system that categorizes or scores the project assessment and readiness based on a number of predefined tiers. According to one practice, the tier system can employ four tiers, namely tier 1 which indicates that the project scope or readiness is not yet in place; tier 2 which indicates that a partial completion of the project scope; tier 3 which indicates that the project is substantially complete and sufficiently defined to facilitate a reliable cost estimate and schedule estimate; and tier 4 which indicates that the project scope is established, detailed and comprehensive in all aspects based on commitments or supporting documentation. As noted, the project readiness assessment unit 14 can generate the project assessment data 16, which can include the project assessment scores generated by the scoring unit 44. The project assessment data 16 can be indicative of an assessment of the readiness of the project across multiple different assessment fields and criteria, including overall project characteristics, proposed execution strategy, and overall project design. The project assessment score 16 is indicative of a readiness of the project, or can be employed to identify, and if needed, rank or determine the readiness of the project relative to peer enterprises, so as to identify and prioritize any identified risks associated with the project, and to stage-gate the project so as to ensure that the project is ready to move to the next project phase, such as full funding, construction, and the like. The project data can include stage data and gate data. The term “stage” or “stage data” refers data associated with distinct phases or steps in the project lifecycle, typically represented as a linear sequence. Each stage focuses on specific activities, such as research, planning, design, development, testing, and launch. The stages can vary depending on the nature of the project or the enterprise's preferred approach. For example, the project stages can include concept development, feasibility analysis, prototyping, and commercialization. The term “gate” or “gate data” represents review or decision points or gates that occur at the end of each project stage and hence can function or act as go/no-go checkpoints. The gating functionality can be automated by the project readiness assessment unit 14 and can analyze selected portions of the project data, such as deliverables and supporting information, to assess the project's progress, evaluate the project's alignment with strategic goals, validate assumptions, and determine whether to proceed to the next project stage. The stage gate functionality can impact the interpretation of the score as well as the benchmarking of the score as score targets. For example, a score of 50 during planning can be interpreted differently than a score of 50 during construction. The stage-gate methodology provides several benefits. The methodology enhances project management discipline, improves resource allocation and utilization, facilitates effective decision-making, reduces the risk of investing in unviable projects, increases transparency and accountability, and encourages cross-functional collaboration. By using this approach, the project planning and assessment system 10 can ensure that projects are properly planned, evaluated, and controlled, leading to more successful outcomes and minimizing the chances of wasted resources on initiatives that do not meet the desired criteria. The project assessment data 16 and the project assessment score can be conveyed to a reporting unit 34 that can employ a user interface generator for generating one or more user interfaces for generating and displaying on a display device one or more suitable reports. The report can include or employ the project assessment data 16.

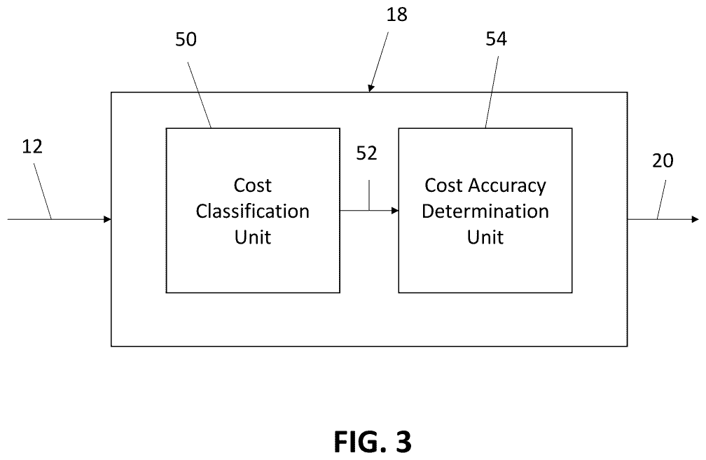

As shown in FIGS. 1 and 3, the project planning and assessment system 10 can include a project diagnostic and cost assessment unit 18 for receiving the source data 12 from the data sources 11. The source data 12 can include any selected type of project data, including project cost data and project scope data. The project cost data can include project cost estimate data. The illustrated project diagnostic and cost assessment unit 18 can be configured to determine an accuracy of project cost estimates associated with the project, as well as to classify the project cost estimates. The project diagnostic and cost assessment unit 18 can include a cost classification unit 50 for classifying the source data 12, including the project cost data which includes the project cost estimate data, into one or more of a plurality of cost classifications. The cost classifications can correspond to any selected portion of the project. Further, one or more of, or each of, the cost classifications can optionally have a plurality of cost subclassifications associated therewith. According to one embodiment, the cost classifications can include a process industry cost classification and a general building cost classification. Those of ordinary skill in the art will readily recognize that different types of classifications can also be employed by the classification unit 50 of the present invention. Further, the process industry classification can include a plurality of cost subclassifications. According to one embodiment, the cost subclassifications can include two or more of (or three or more of; or four or more of; or five or more of) a project scope description subclassification, a plant production or facility capacity subclassification, a plant location subclassification, a soil and hydrology subclassification, an integrated project plan subclassification, a project master schedule subclassification, an escalation strategy subclassification, a work breakdown structure subclassification, an escalation strategy subclassification, a project code of accounts subclassification, a contracting strategy subclassification, a diagrams subclassification, a plot plans subclassification, a process flow diagrams subclassification, a utility flow diagrams subclassification, a piping and instrument diagrams subclassification, a heating material balances subclassification, a process equipment list subclassification, a utility equipment list subclassification, an electrical drawing subclassification, a specification and data sheet subclassification, a general equipment arrangement subclassification, a spare parts subclassification, a mechanical discipline drawings subclassification, an electrical discipline drawings subclassification, an instrumentation and control system subclassification, and a civil and structural site discipline subclassification.

Similarly, the general building cost classification of the classification unit 50 can include a series of cost subclassifications, including, for example, two or more of (or three or more of; or four or more of; or five or more of) an assessment area subclassification, a project general scope description subclassification, a project location subclassification, a building area subclassification, a functional space requirements subclassification, a building specific subclassification, an exterior closure description subclassification, a finishes description and requirements subclassification, a building code or standards requirement subclassification, a mechanical systems and total capacity subclassification, an electrical capacity subclassification, a communication system subclassification, a fire protection and life safety requirements subclassification, a security system subclassification, an antiterrorism force protection requirements subclassification, a LEED certification level subclassification, a soil and hydrology subclassification, an integrated project plan subclassification, a project master schedule subclassification, a work breakdown structure subclassification, a project code of accounts subclassification, a contracting strategy subclassification, and escalation strategy and basis subclassification, a building codes and standards subclassification, a site plan subclassification, a demolition plan and drawing subclassification, a utility plan and drawing subclassification, a site electrical plan and drawings subclassification, a site lighting plan and drawing subclassification, a site communications plan and drawing subclassification, an erosion control plan subclassification, a stormwater plan subclassification, a landscape plan subclassification drama an exterior elevations subclassification, an interior elevations subclassification, an interior section views subclassification, a partition type subclassification, a fender schedule subclassification, a door schedule subclassification, a window schedule subclassification, a restroom schedule subclassification, a furniture plan subclassification, a signage subclassification, a fire protection plan subclassification, a room layout plan subclassification, a foundation plan subclassification, a foundation section subclassification, a structural plan subclassification, a roof plan subclassification, a building envelope subclassification, material and equipment subclassification, a mechanical and HVAC subclassification, a flow control subclassification, a plumbing subclassification, and electrical subclassification, a lighting subclassification, and an information systems and telecommunications subclassification.

The cost classification unit 50 generates classification data 52 that is indicative of the source data 12 that has been classified into one or more of the cost classifications and two or more of any associated cost subclassifications. The classification data 52 is then received and processed by a cost accuracy determination unit 54. The cost accuracy determination unit 54 automatically processes the classification data 52 and then generates based thereon a project cost accuracy score associated with each of the cost classifications and cost subclassifications. The cost accuracy determination unit 54 can determine the project cost accuracy score for each cost classification by summing together the cost accuracy scores of the corresponding or associated cost subclassifications. Likewise, the cost accuracy determination unit 54 can determine an aggregate, overall or total project cost accuracy score 20 by summing together the cost accuracy scores for each of the cost classifications. The project cost accuracy score is indicative of the accuracy of the provided project cost data relative to predetermined cost estimates or estimates forming part of industry standards. As used herein, the term “project cost accuracy” and “cost accuracy” refer to the degree to which the estimated cost of a project aligns with the actual cost of completing the project, so as to enable the project participants and the project stakeholders to evaluate the success of a project and identify areas for improvement. The project cost accuracy and associated score can be determined by comparing the estimated cost of the project, which is usually based on a detailed project plan and budget, with the actual cost of completing the project. The actual project costs and the estimated project costs form part of the project data. The accuracy of the cost estimate can be measured in selected ways by employing one or more project cost measurement techniques, including for example by using a percentage deviation technique, a root mean square error (RMSE) technique, a mean absolute error (MAE) technique, a standard deviation technique, and the like. The percentage deviation technique is a method of measuring cost accuracy that involves calculating the percentage difference between the estimated project cost and the actual cost of the project from the project data. The RMSE technique involves calculating the square root of the average of the squared differences between the estimated project cost and the actual project cost from the project data. The MAE technique involves calculating the average of the absolute differences between the estimated project cost and the actual project cost from the project data. The standard deviation technique involves calculating the standard deviation of the differences between the estimated project cost and the actual project cost from the project data. The project cost accuracy and any associated project cost accuracy score can be influenced by various project related factors, such as project scope, project complexity, and the accuracy of the initial project estimation.

Alternatively, the cost accuracy determination unit 54 can use one or more project cost estimation or comparative analysis techniques to determine the project cost estimate or the accuracy of the project cost estimate based on the project data 12 forming part of the classification data 52. For example, the project cost estimation technique can include one or more of an analogous estimation technique that involves estimating the cost of a new project based on the cost of a similar project that has already been completed; a bottom-up estimation technique that involves breaking down the project into smaller components and estimating the cost of each component; a three-point estimation technique that involves estimating the best-case scenario, the worst-case scenario, and the most likely scenario for each task of the project; a parametric estimation technique that involves using statistical models and historical data to estimate the cost of the project; an expert judgment estimation technique that involves consulting with experts in the field to estimate the cost of the project; and a reserve analysis estimation technique that involves adding a contingency reserve to the estimated cost to account for the risk and uncertainty associated with the project. The project cost accuracy scores can be determined or be based on the class of project cost estimate and the class of project cost estimate is based on the level of detail and stage of the estimate maturity of the project's design.

The project cost accuracy scores generated by the cost accuracy determination unit 54 helps assess or determine a reliability or predictability of the project cost estimates and thus serves as a quantitative measure of accuracy of the estimated project costs. The project cost accuracy scores can thus be based on classes of project cost estimates that are based on the project's stage and available information. The cost accuracy determination unit 54 generates a score that is indicative of the level and stage of maturity of the project design at a detailed level. The level of maturity of the project can then be evaluated against the current estimate and the expected accuracy of the estimate based on selected guidelines. The project cost estimate classes can include, for example, conceptual, preliminary, and detailed project cost estimates, each representing different levels of detail and accuracy that can serve as benchmark criteria against which the accuracy of the project cost estimates in each class is evaluated. According to one embodiment, the actual project costs incurred during the project's execution are compared with estimated project costs for each class of estimates. The comparison can involve analyzing project cost variances, evaluating project cost performance indices, or other relevant comparative analysis techniques. Based on the comparison of estimated project costs and actual project costs, the project cost accuracy scores for each class of cost estimates can be determined. The project cost accuracy scores typically measure the deviation or performance of the estimates against established benchmarks. The cost accuracy determination unit 54 can determine one or more project cost accuracy scores including a cost variance (CV) score, a cost performance index (CPI) score, an accuracy ratio (AR) score, a forecast accuracy index (FAI) score.

For example, the cost accuracy determination unit 54 can determine the project cost accuracy or variance score by determining a difference between the estimated project cost and the actual project costs incurred. A positive project cost score indicates that the project is under budget, while a negative project cost score indicates cost overruns. The cost accuracy determination unit 54 can alternatively determine the cost performance index ratio score by determining a ratio of the earned project value (i.e., the budgeted project cost of work performed) to the actual project cost incurred. A CPI ratio score greater than 1 indicates that the project is performing better than expected, while a CPI ratio score less than 1 indicates cost inefficiencies. The cost accuracy determination unit 54 can also alternatively determine the accuracy ratio score by dividing the actual project cost by the estimated project cost. An AR score value close to 1 indicates a high level of accuracy, while values significantly higher or lower indicate a deviation from the estimate. Still further, the cost accuracy determination unit 54 can determine the forecast accuracy index score by measuring the accuracy of the cost estimate's ability to predict future costs. The FAI score can be calculated by dividing the remaining budget by the forecasted cost to complete. An FAI score close to 1 indicates accurate forecasting, while values significantly higher or lower indicate deviations. The calculated project cost accuracy scores can be employed to assess the performance and accuracy of the project cost estimates for each class. Positive scores indicate accurate or favorable estimates, while negative scores suggest deviations or inefficiencies. The interpretation of accuracy scores helps project stakeholders understand the strengths and weaknesses of the estimating process and identify areas for improvement. The project diagnostic and cost assessment unit 18 can then generate project cost accuracy score data 20.

According to still another embodiment, the cost accuracy determination unit 54 can employ a maturity model to determine the project cost score 20. The maturity model can provide a roadmap for cost improvement by defining a progression of maturity levels or tiers, each representing a higher state of development and optimization. Each level or tier can have specific criteria associated therewith that defines what must be achieved to be considered at that level. As such, the project cost scores can be based on any selected type of tiered scale, where an example of a suitable scale is a scale of 1-4, where each project cost score is indicative of a selected project cost tier. The maturity model can be defined as part of the Cost Engineering International (AACE International) standards for the quantitative project cost scoring section and the associated tiered scoring model for qualitative areas. The project cost accuracy score 20 can be conveyed to the reporting unit 34 for generating and displaying one or more suitable reports. The report can include or employ the project cost accuracy score data 20.

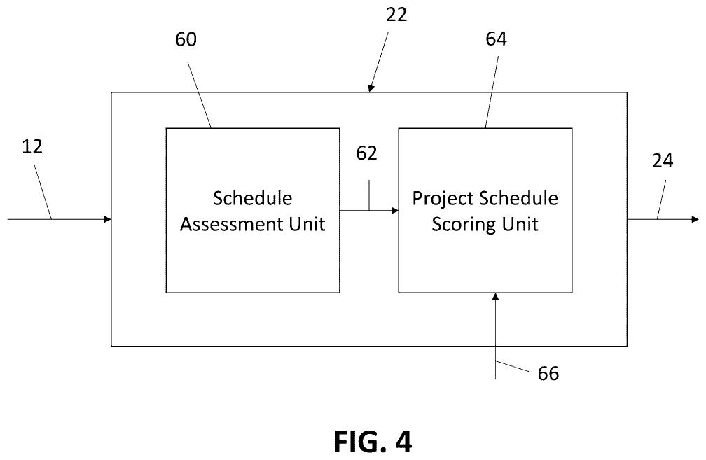

As shown in FIGS. 1 and 4, the project planning and assessment system 10 of the present invention can include a project schedule assessment unit 22. The illustrated project schedule assessment unit 22 can receive the source data 12 which includes project data, and the project data can include project schedule data including a project schedule plan, and processes the project schedule data to determine a project schedule score. As used herein, the term “project schedule” and associated data can refer to the information or data used to create and maintain a schedule or schedule plan for the project. The project schedule information can include a project plan, project tasks or activities, project start and end dates, project stages, project dependencies on other project related tasks or activities, and the like. Other project schedule data can include resource availability, resource allocation, task duration estimates, and any constraints or limitations that can impact the project schedule. The project schedule data can be used to develop a project schedule, which is essentially a roadmap or plan for the project's execution. The project schedule helps to ensure that the project is completed on time and within budget, and provides a framework for managing resources, tracking progress, and identifying potential risks or issues. When creating the project schedule, the project planning and assessment system 10 collates and processes relevant project schedule data from a variety of different sources, such as from project management software, stakeholder input, historical data, and subject matter experts. Once the project schedule data is collected and organized, the project schedule data can be used to create a project schedule that accurately reflects the project's timeline and resources, and thus helps to ensure successful project delivery.

The illustrated project schedule assessment unit 22 can employ a schedule assessment unit 60 for applying one or more project schedule analysis and assessment techniques to the project schedule data 12 to assess and evaluate a quality and an accuracy of the project schedule forming part of the project schedule data. As used herein, the terms “accuracy” as it relates to a project schedule, “schedule accuracy,” “project schedule accuracy” or “accuracy of a project schedule” is intended to mean or refer to how closely a project's actual progress matches a planned project schedule. The schedule accuracy can be a measure of how well a project is able to adhere to a predetermined timeline and deadlines established as part of a project plan or schedule. The schedule accuracy can be expressed as a score, which can be a raw number, a percentage, or a ratio, by comparing the actual duration of the project activities against a planned duration. For example, if a project schedule had a planned duration of 10 weeks and the actual duration was 9 weeks, the schedule accuracy would be 90%. A higher schedule accuracy indicates that the project participants have been successful in executing the project plan and delivering the project on time according to the project schedule, while a lower schedule accuracy score indicates that the project has encountered delays or issues that have impacted the project schedule. As used herein, the term “quality” as it relates to a project schedule, “schedule quality,” “project schedule quality,” or “quality of a project schedule” can mean or refer to a level of effectiveness and reliability of a project schedule. A high-quality project schedule can be one that accurately reflects the scope, duration, and sequencing of project activities and provides a realistic timeline for completing the project. The project schedule can also consider any constraints, dependencies, and risks that can affect the project timeline. A high-quality project schedule can be developed through a planning process, with input from the project stakeholders and project participants, including project managers, team members, and other relevant parties. Further, the quality of a project schedule can be measured by various metrics, including the accuracy of estimates, the completeness of the project schedule, the level of detail provided, and the level of alignment with project goals and objectives. A high-quality project schedule forms part of an effective project management, as the schedule helps ensure that the project is completed on time and within budget while minimizing risks and maximizing efficiency. Further, the schedule analysis and assessment technique can evaluate the project schedule, including performing one or more of a critical path analysis, a schedule margin analysis, and a schedule performance analysis. One example of a suitable schedule analysis and assessment technique that can be employed by the schedule assessment unit 60 to assess the quality and accuracy of the project schedule can include the schedule analysis tool developed by the Defense Contract Management Agency (DCMA). The schedule analysis and assessment technique can be configured to evaluate the accuracy and quality of a project schedule, identify potential problems and risks, and provide feedback or generate insights on how to improve the project schedule. The schedule assessment unit 60 can generate project schedule assessment data 62.

According to one embodiment, the schedule analysis and assessment technique can analyze the project schedule data and evaluate the quality and accuracy of the project schedule based on a set of predetermined project criteria. The project criteria can include two or more of (or three or more of: or four or more of: or five or more of) a project logic criteria, project lead criteria, project lag criteria, project relationship criteria, project hard restraint criteria, high float criteria, a negative float criteria, high duration task, invalid dates criteria, resources criteria, missed tasks criteria, critical path test criteria, a critical path length index (CPLI) criteria, and a baseline execution index (BEI). The project logic criteria determines the project tasks that are complete and incomplete, and whether the tasks have defined predecessor and successor tasks associated therewith. The project lead criteria can refer to a negative lag, during which one task starts before the predecessor task is finished. The project lag criteria can refer to a positive lag, which occurs when the start of one task is delayed relative to the finish of a predecessor task. Positive lags can also negatively affect analysis of the project's critical path. The project relationship criteria refers to relationships between tasks in a finish-to-start relationship order, in which one task cannot begin until a predecessor task is completed. The sequencing of the tasks in the project schedule can provide an understanding of a critical path for the project and associated schedule. Other examples of relationship types can include a start-to-start and a finish-to-finish relationship, in which one task cannot start or finish until a predecessor task is started or finished. These relationships can be used when the tasks correspond with a true dependency of the tasks. The project hard constraint criteria refer to project or activity completion deadlines. The high float criteria refer to the amount of time that a project related task can be delayed without affecting the project's critical path and is representative of missing task dependencies within the project schedule. The negative float criteria refer to a delay that occurs when the project schedule predicts a missed deadline or when a hard constraint is delaying a project task. Negative float is thus indicative of a future project task date that is likely to be missed. The high duration task refers to tasks that extend beyond a selected time period or duration.

The schedule analysis and assessment techniques can segment the high duration tasks into a series of shorter tasks. The invalid date criteria can refer to project tasks having anticipated (future) task begin dates that are now in the past and have associated to be completed work dates that are now in the future. The resources criteria refer to assigning resources to each project task. The missed tasks criteria can represent a schedule performance compared to a baseline plan. As such, the missed tasks refer to the percentage of activities that were expected to have been finished as of the project's current status date, but that have actual or forecasted finish dates later than those in the baseline schedule. The critical path test criteria can be used to evaluate an integrity of the schedule's network logic. First, the critical path of the schedule is identified. Then, an amount of schedule slip, or a disruption to the planned schedule, is introduced to delay the first task. If a comparable amount of schedule slip occurs in the project's finish milestone, then the critical path test has passed. A failed test represents missing dependencies and often leads to a deeper analysis of the network logic. The critical path length index measures the efficiency required to complete a project. The index can be determined by taking the sum of the remaining project duration, or the number of working days remaining on the critical path, and the total float, and then dividing the value by the remaining project duration. In this scenario, the total float refers to the variance between the forecasted and baseline finish dates of the project. A CPLI value of 1 means that the schedule can proceed exactly as planned for the remainder of the project. A value above 1 reveals that there is a remaining schedule margin. A value below 1 shows that the project team has to overachieve to finish by the baseline finish date. The baseline execution index is a warning indicator that reveals when a project schedule is at risk of not meeting a predetermined deadline. The BEI can be calculated by dividing the total number of completed activities by the total number of tasks that were expected to be complete as of the project status date. A BEI of 1 means the project team is performing on plan, a value above 1 reveals the project is ahead of schedule, and a BEI below 1 means the project is behind schedule.

The project schedule assessment data 62 generated by the schedule assessment unit 60 is received and processed by a project schedule scoring unit 64. The project schedule scoring unit 64 is configured to receive the project schedule assessment data 62, as well as third party project schedule scoring data 66 from a third party. The third-party project schedule scoring data 66 can be generated by any suitable third party, such as a subject matter expert, that independently assesses the quality and accuracy of the project schedule and generates scoring data associated therewith. The project schedule scoring unit 64 processes one or more of the project schedule assessment data 62 and the third-party project schedule scoring data 66 to generate an overall project schedule score 24 that is indicative of the quality and accuracy of the project schedule. For example, the project schedule scoring unit 64 can determine the project schedule score 24 based on the project schedule data 62. Further, the project schedule scoring unit 64 can determine a project schedule score 24 for each of the project criteria, and the project schedule scoring unit 64 can sum the scores associated with each of the project criteria to determine the overall project schedule score. The project scores associated with each project criteria can be weighted differently relative to each other based on predetermined weighting factors. The project schedule scoring unit 64 can determine the overall project schedule score by summing together the project schedule scores associated with the project criteria with the third-party project schedule score. The project schedule assessment unit 22 is configured to assess the quality and accuracy of the project schedule and to generate the project schedule data 24. The project schedule data 24 can include the project schedule score and is indicative of a certain level of confidence the project participants have in the project schedule. The ability to assess the quality and accuracy of the project schedule helps the project participants identify opportunities for improvement in the project schedule and to increase the likelihood of the project being successfully and timely completed. Further, the project schedule data 24 can be used in reports generated by the reporting unit 34 to easily identify any project scheduling issues and to allow the project participants to facilitate rapid remediation and schedule improvement activities. Still further, the project schedule assessment unit 22 allows the project participants to properly assess, over time, the various tasks associated with the project and the timeliness of task completion.

According to an alternate embodiment, the project schedule scoring unit 64 can employ a maturity model to determine the project schedule score 24. The maturity model can provide a roadmap for cost improvement by defining a progression of maturity levels or tiers, each representing a higher state of development and optimization. Each level or tier can have specific criteria associated therewith that defines what must be achieved to be considered at that level. As such, the project schedule scores 24 can be based on any selected type of tiered scale, where an example of a suitable scale is a scale of 1-4, where each project schedule score is indicative of a selected project schedule tier. The maturity model can be defined as or form part of the Defense Contract Management Agency (DCMA) standards for quantifying schedule quality. The project schedule score 24 can be conveyed to the reporting unit 34 for generating and displaying one or more suitable reports. The report can include or employ the project schedule score data 24.

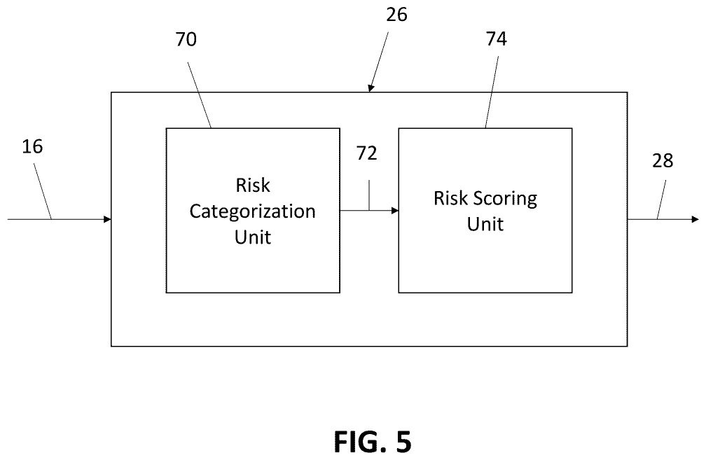

With reference to FIGS. 1 and 5, the project planning and assessment system 10 of the present invention can include a project risk assessment unit 26. The illustrated project risk assessment unit 26 can receive and process the project data that is in the source data 12, where the project data includes project risk data, for determining an inherent risk level, rating or score associated with the project. As used herein, the term “risk” as it relates to the project, “project risk”, “inherent risk”, “inherent risk level”, “inherent risk rating”, or “inherent risk score” is intended to describe, represent, or be indicative of a level or rating of risk that is inherent in a particular project or related to specific tasks of the project, with or without taking into account any measures that can be taken to mitigate the risk. As such, the inherent risk level, rating or score is a measure of the potential for adverse events or circumstances to occur during the course of the project that can have a negative impact on the outcome of the project and impact the timely completion of the project. The inherent risk rating or score can be based on a number of risk factors or elements, such as the complexity of the project, the level of uncertainty involved with the project, the size of the project, the number of stakeholders involved with the project, and the degree of innovation required to complete the project. The risk factors or elements can contribute to a higher or lower level of inherent risk, and therefore impact the overall risk score for the project. A higher inherent risk score indicates a higher level of risk, while a lower inherent risk score indicates a lower level of risk. The inherent risk score can help identify potential risks and enable appropriate measures to be taken to mitigate the risks. High-risk projects have a higher inherent risk rating since they are more likely to encounter unexpected challenges or obstacles that can derail the project. Low-risk projects can be associated with a lower inherent risk rating, as they are generally more straightforward and less likely to experience major setbacks.

The illustrated project risk assessment unit 26 can include a risk categorization unit 70 suitable for automatically classifying or categorizing the project risk data 12 into a series of project risk categories. Each of the project risk categories can include a series of project risk subcategories. The project risk categories can include, for example, one or more of (or two or more of; or three or more of) a program or project strategy category, a program or project delivery category, an external or influencing factors category, an organizational framework category, a financials category, an empowerment category, and the like. Each of the project risk categories can optionally have two or more risk subcategories associated therewith, where the user can input project risk data and associated risk consequence data based on the project data. The inherent risk score generated by the project risk assessment unit 26 can be based on the project risk data and optionally a set of identified risk elements, factors, or events. The risk elements that can affect the inherent risk score include project complexity, project uncertainty, project consequences, time pressure, skill level, and other external factors. For example, project complexity can refer to the complexity of a task or project, which can increase the inherent risk, as more complex activities are generally more difficult to manage and control. The project uncertainty can refer to the level of uncertainty associated with a task or project, which can also increase the inherent risk. For example, if there is a high degree of uncertainty around the outcome of a particular activity, this can increase the overall risk. The potential consequences of a risk event can also impact the inherent risk rating. For example, if a particular risk event has the potential to cause significant financial loss or damage to a company's reputation, this will increase the inherent risk. Further, if there is a tight deadline or time pressure associated with a particular task or project, this can increase the inherent risk, as there may be a greater chance of errors or oversights. The skill level of individuals involved in a particular activity can also impact the inherent risk rating. For example, if a particular task requires a high level of skill or expertise, but the individuals involved are not adequately trained or experienced, this can increase the inherent risk. External factors such as economic conditions, regulatory changes, or natural disasters can also impact the inherent risk rating of a particular activity. Further, risk scoring unit can determine the inherent risk score by summing together a category risk score generated for each of the plurality of project risk categories, and the category risk scores can be determined by summing together a subcategory risk score for each of the plurality of project risk subcategories associated with each of the plurality of project risk categories. The risk categorization unit 70 can generate risk categorization data 72.

The project risk assessment unit 26 can also include a risk scoring unit 74 for generating the inherent risk score 28 based on the risk categorization data 72. The inherent risk scores can be normalized by the risk scoring unit 74 and can be expressed based on any suitable scale. The inherent risk score can be a total or aggregate score or can be calculated for each risk element by evaluating the consequence of a risk and the likelihood of an occurrence. Further, the risk scoring unit 74 can optionally employ a preselected or predetermined risk threshold score, and the risk scores of each risk category or subcategory can be compared with the risk threshold value. Based on the comparison, for example if the inherent risk score or the risk category scores are above the threshold risk score, then the project risk assessment unit 26 can recommend or perform one or more project risk actions or plans. The action plans are related to the type or category of risk. For example, if the enterprise is overly reliant on technology firms for innovations and supply of specialist equipment and spares, then the project action plan can include formalizing a communication plan, document management, as well as establish a risk management team. If the enterprise is overly dependent on a limited number of vendors or suppliers for project deliverables, then this over-reliance can adversely impact project time and costs due to resource constraints and potential delivery default by vendors. The project action plan can initiate global procurement for capital projects and develop strategies together with the suppliers to define a risk mitigation plan. If the vendor fails to supply important equipment or material in time, this failure can lead to delays in project execution and can cause cost overruns on account of idling of resources at project site. The project action plan can align internally resources that make use of the same suppliers, with strategies that can be adopted with the suppliers. Still further, the project risk assessment unit 26 can optionally generate an inherent risk score based on any suitable risk rating scale or tier, such as for example on a scale or tier of 1-4 or 1-5, where each risk score is indicative of a selected risk rating. The tiers can form part of a tiered scoring methodology. According to one embodiment, a risk score of 1 can be indicative of a low risk level where the likelihood of the risk is rare; a risk score of 2 can also be indicative of a low risk level where the likelihood of the risk is unlikely; a risk score of 3 can be indicative of a medium risk level where the likelihood of the risk is possible; a risk score of 4 can be indicative of a higher risk level where the likelihood of the risk is major; and a risk score of 5 can be indicative of a relatively high risk level where the likelihood of the risk is catastrophic. The project risk assessment unit 26 can be configured to set a risk tolerance level for each project. The inherent risk score can be dynamically calculated or determined by the project risk assessment unit 26, and specifically by the risk scoring unit 74, during different phases or time periods of the project. As such, the inherent risk score can be dynamically calculated by the project risk assessment unit 26 and the inherent risk score can change over time, enabling the project participants to track and to monitor the project as the project progresses. The project risk assessment unit 26 can also employ one or more machine learning models or techniques to process the project schedule data, and optionally the inherent risk score generated by the project risk assessment unit 26, to generate one or more recommendations on how to improve the risk profile of the project by determining or recommending one or more suitable project risk actions, such as remediation or mitigation plans or actions. The machine learning model can be trained on the project data, such as the project risk data, in order to provide suitable recommendations. The project risk assessment unit 26 can generate project risk data that includes the inherent risk score 28. The inherent risk score 28 can be conveyed to the reporting unit 34 for generating one or more reports based thereon.

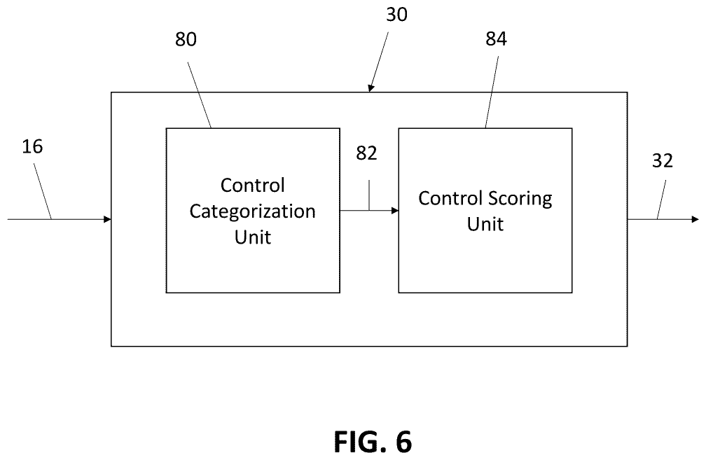

With further reference to FIGS. 1 and 6, the project planning and assessment system 10 of the present invention can include a project control assessment unit 30 that can be configured to receive and process project control data forming part of the input project data, and for processing and assessing one or more project controls associated with the project. Specifically, the illustrated project control assessment unit 30 can receive and process the project control data. The project control data can include or refer to a set of processes and tools that are used to plan, monitor, and control the scope, schedule, budget, and quality of a project, so as to ensure that the project is completed on time, within budget, and to the required quality standards. The project control assessment unit 30 enables the project participants, based on the generated information, to make informed decisions and to take corrective actions when necessary. The project control assessment unit 30 can generate project control data that includes a project control score 32 that can be received by the reporting unit 34 to generate one or more reports based thereon.

The illustrated project control assessment unit 30 can include a control categorization unit 80 for classifying the project control data 12 into one or more of a plurality of control categories. The control categories can correspond to any selected portion of the project control data. Further, one or more of, or each of, the control categories can optionally have a plurality of control subcategories associated therewith. According to one embodiment, the control categories can include a program or project strategy category, an organization and administration category, a cost management category, a procurement management category, a project controls and risk management category, a schedule management category, a sustainability category, a soft controls category, and the like. Each of the control categories can have a plurality of control subcategories associated therewith, and each control subcategory can optionally have a plurality of assessment queries associated therewith. As used herein, the term “assessment query” is intended to mean or refer to a request or inquiry made to evaluate or examine the project control data, and can involves gathering project control information, analyzing the project control data, and making recommendations or assessments based on the results. The purpose of the assessment query is to gain a deeper understanding of the project controls, assess strengths and weaknesses of the project controls, identify potential areas for improvement of the project controls, and make informed decisions or recommendations based on the assessment results. The assessment queries can help evaluate the effectiveness and performance of the controls within each category. The project control scores for each category can be optionally normalized and can be expressed based on any suitable scale or aggregate or total score. For example, the control scoring unit 84 of the project control assessment unit 30 can optionally generate an overall project control score. Specifically, the control scoring unit 84 receives the control categorization data 82 and then, based thereon, can generate the project control score 32. The project control score 32 can be determined by generating a project cost accuracy score associated with each of the control categories and each of the control subcategories. The control scoring unit 82 can determine a control score for each control category by summing together the control scores of the corresponding or associated control subcategories. Likewise, the control scoring unit 84 can determine an aggregate, overall or total project control score 32 by summing together the control scores for each of the control categories. Alternatively, the control scoring unit 84 can employ a maturity model to determine the project control score 32. The model provides a roadmap for improvement by defining a progression of maturity levels or tiers, each representing a higher state of development and optimization. Each level or tier can have specific criteria associated therewith that defines what must be achieved to be considered at that level. As such, the project control scores can be based on any selected type of tiered scale, where an example of a suitable scale is a scale of 1-4, where each control score is indicative of a selected project control rating.

For example, a project control score of 1 can be associated with project control information that is unreliable, informal, or unpredictable. An informal or unpredictable environment associated with the project means that any project controls or control activity is not currently contemplated or in place, no control procedure documentation exists, and therefore, no monitoring or improvement activities are occurring. A project control score of 2 can be deemed to be a standard project score, and which typically indicates that suitable project controls and associated control activity has been designed and is in place and appears to be adequately documented. However, the control documentation is deemed to be below peer level firms documentation and there are no established monitoring activities in place which can be employed to test improve project control activities. A project control score of 3 can be indicative of control designs that appear to be adequately documented for standardized use across the enterprise and appear to function appropriately when compared to peer level enterprises of similar size, industry and project type. Further, the project control score also indicates that the control or activity designs appear to be adequately documented for standardized use across the enterprise and appear to outperform peer enterprises of similar size, industry and project type. A project control score of 4 can be indicative of control or activity designs that appear to be optimally documented for use across the enterprise and appear to outperform peer enterprises of similar size, industry and project type. The project control assessment unit 30 can be configured to set a project control score for each project. The project control score can be dynamically calculated or determined by the project control assessment unit 30 during different phases or time periods of the project. As such, the project control scores can change over time, enabling the project participants to track and monitor the project controls as the project progresses. The project control assessment unit 30 can also employ one or more machine learning techniques to process the project control data to generate one or more recommendations on how to improve the controls associated with the project by determining or recommending one or more suitable control plans or actions. In this regard, the machine learning model can be trained on project control data. The project control assessment unit 30 can generate project control score data 32. The project control score data 32 can be conveyed to the reporting unit 34 for generating one or more reports based thereon.

The project planning and assessment system 10 can also be configured to provide selected benchmarking capabilities so as to allow for a comparison of results from various assessment units, such as the project readiness assessment unit 14, the project diagnostic and cost assessment unit 18, the project schedule assessment unit 22, the project risk assessment unit 26, and the project control assessment unit 30, based on industry, client, project profile, and other attributes. Incorporating benchmarking capabilities into the project planning and assessment system 10 of the present invention enables the system to provide real-time project comparison data for the enterprise and reduce the amount of manual effort required to compare benchmarking results and graphics, thereby, allowing resources to be deployed more efficiently and effectively. The project planning and assessment system 10 can also provide for dynamic benchmarking across various industries, enterprises, and project types so as to assist the enterprise in developing targeted and nuanced recommendations for project improvement. The reporting unit 34 can also generate, based on the types of input data (e.g., data 16, 20, 24, 28, and 32) comparative scorecards at various assessment category levels, including identification of trends, outliers, and potential challenges to support reporting and client discussions.

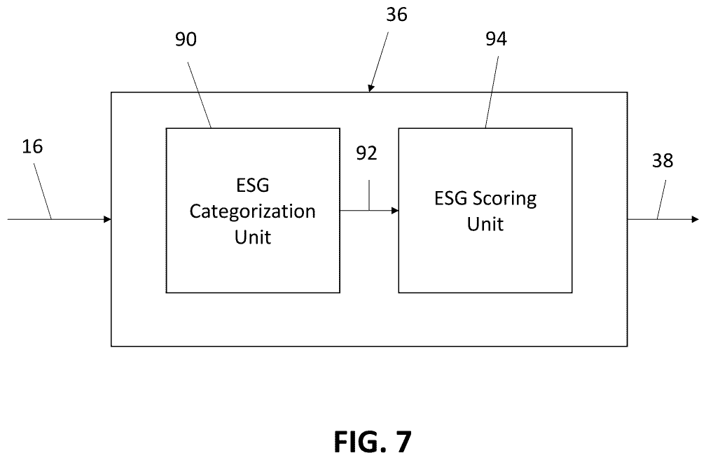

The project planning and assessment system 10 can also be configured to include an optional Environmental, Social and Governance (ESG) assessment unit 36 for considering and assessing selected ESG standards relative to the project. The ESG assessment unit 36 is shown for example in FIG. 7. The illustrated ESG assessment unit 36 can receive ESG data forming part of the project data 16 and then process the ESG data to determine an ESG score 38 associated with the project. The ESG data can include selected ESG standards that are guidelines for the enterprise to follow or ESG related goals for the enterprise to attain or to achieve. The standards can also embody enterprise specific ESG policies. The ESG standards and policies are essentially a cohesive methodology that can helps the enterprise rely on a single system or framework or guidelines and standards to assess the ESG performance of the project and how the project relates to the ESG standards of the enterprise. Specifically, the ESG standards are a set of criteria that the enterprises use to measure and report on their impact in three general areas, namely, the environment, social responsibility, and corporate governance. The ESG standards help investors, customers, and other stakeholders evaluate how the enterprise is managing risks and opportunities related to these factors.

Specifically, the ESG assessment unit 36 can be configured to include an ESG categorization unit 90 for classifying or categorizing the ESG data 12 into one or more of a plurality of ESG categories. Further, one or more of, or each of, the ESG categories can optionally have a plurality of ESG subcategories associated therewith. According to one embodiment, the ESG categories can include a conceptual category, a design category, a procurement category, a construction category, an operations category, and a decommissioning category. Each of the ESG categories can have a plurality of ESG subcategories associated therewith. For example, the ESG subcategories associated with one or more of or each of the conception, design, procurement, construction, and decommissioning categories can include an environmental subcategory that includes or is related to one or more of (or two or more of; or three of more of) ESG factors including decarbonization, materials and resource, water efficiency, energy usage, ecology and biodiversity, sustainable sites, indoor air quality, and resiliency; a social criteria subcategory that includes or is related to one or more of (or two or more of; or three of more of) ESG factors including diversity, equity and inclusion (DEI), workforce and skills data, health and wellbeing, safety and ergonomics; and a governance criteria subcategory that includes or is related to one or more of (or two or more of; or three of more of) ESG factors including controls management, ethical behaviors, risk and opportunity, investment and economics, and technology. The design category can include one or more of a design environmental subcategory, a design social criteria subcategory and a design governance subcategory.

The decarbonization factor includes removing or reducing carbon emissions during the project. This can be achieved by reducing demand or increasing reuse of resources and optimizing construction and production processes. The material factor can include circular economy of products and resources used in their production, transportation, use, and disposal. The water efficiency factor can relate to the reduction in the requirement or optimization of water both in facility operating systems and during project construction. The energy use factor relates to optimizing the consumption of resources for power, identifying opportunities for power generated by renewable resources, and monitoring of power consumption. The ecology and biodiversity factor relates to or includes landscaping and facility exteriors that can impact the surrounding environment, such as native species, pervious/impervious pavement, heat island effect, light pollution, and the like. The sustainability site factor relates to site location selection and the site proximity to transportation, businesses, and community centers, and the upkeep of the construction site; prevention of excess waste, dust, exposure, and construction/demolition waste removal. The indoor air quality factor relates to the creation of an indoor environment that is not harmful to both the environment and subsequently the people that inhabit the space. This includes using materials that do not emit harmful chemicals/VOCs, the use of passive heating and daylighting, and construction processes that keep particles (e.g., silica) from entering the HVAC systems. The resiliency factor relates to the use of systems that continue to perform efficiently under changing environmental conditions. The factor also includes contingency and disaster planning, and emergency preparedness based on climate risks.

The ESG factors can also include social factors such as workforce skills, diversity, equity and inclusion, (DEI), ergonomics, health and wellbeing, and safety. The DEI factor relates to the appropriate engagement of minority or disadvantaged groups and just treatment policies to give people a fair chance regardless of background within hiring, subcontracting and operating practices. The skills factor relates to human rights monitoring, fair payment and working hours, and training and growth opportunities for employees and workers. The health and well being factor relates to providing benefits such as access to childcare, mental health services, and healthy food options, and providing and encouraging health insurance for employees, workers, and occupants. The safety factor relates to the practice of safety regulations (e.g., OSHA and local DOB requirements) during the construction and operations process of the project. The ergonomics factor relates to the incorporation of methods to promote employee or worker comfort, focus, and efficiency. This factor can include items such as noise reduction, adequate lighting, accommodations, and comfortable temperatures during and after construction.

The ESG factors can further include governance factors including control management frameworks, ethical behavior frameworks, risk and opportunity frameworks, investment and economic frameworks, and technology frameworks. The control management factor relates to decision making methods, project governance framework definitions, and controls identification to meet project goals. The ethical behavior factor relates to policies on hiring practices and wages (e.g., use of union/nonunion labor, prevailing wage), and avoiding conflicts of interest. The risk and opportunity factor relates to identifying risk and opportunity early in the project, understanding risk tolerance of the project, and having mitigation plans in place. The investment factor relates to life cycle costing; scenario analysis and ensuring return of value based on capital expenditures, pursuing and complying with green financing options, and investing into the community. The technology factor relates to project tools and systems for planning, construction, management and performance monitoring of the facility. The factor also incorporates modularization, offsite/onsite production, three-dimensional printing, digital twins, drones, artificial intelligence, analytics and robotics. The ESG categorization unit can categorize the ESG data 12 and then generate ESG category data 92.

The ESG category data 92 can be conveyed to an ESG scoring unit 94 forming part of the ESG assessment unit 36. The ESG scoring unit 94 can generate based on the ESG category data ESG scores for each ESG category, and the ESG scores can be optionally normalized and can be expressed based on any suitable scale or aggregate or total score. For example, the ESG scoring unit 94 receives the ESG category data 92 and then, based thereon, can generate the ESG score 36. The ESG score 38 can be determined by generating an ESG score associated with each of the ESG categories and each of the ESG subcategories. The ESG scoring unit 94 can determine an ESG score for each ESG category by summing together the ESG scores of the corresponding or associated ESG subcategories. Likewise, the ESG scoring unit 94 can determine an aggregate, overall or total ESG score 38 by summing together the ESG scores for each of the ESG categories. Alternatively, the ESG scoring unit 94 can employ a maturity model to determine the ESG score 38. The maturity model provides a roadmap for improvement by defining a progression of maturity levels or tiers, each representing a higher state of development and optimization. Each level or tier can have specific criteria associated therewith that defines what must be achieved to be considered at that level. As such, the ESG scores 38 can be based on any selected type of tiered scale, where an example of a suitable scale is a scale of 1-4, where each control score is indicative of a selected project control rating. By way of example, the ESG scoring unit can generate an ESG score 38 of Tier 1, which indicates that ESG criteria is not defined or in place, there is no ESG vision or goals, no resources are supporting ESG efforts, and no monitoring or improvement activities are occurring. The ESG scoring unit 94 can also generate an ESG score 38 of Tier 2, which indicates that the ESG criteria is partially defined in detail and not comprehensive, and that selected ESG elements have been designed, but there are no clear ownership of ESG initiatives. This score can also indicate that processes are inconsistently documented from which to test and improve the ESG framework. The ESG scoring unit 94 can also generate an ESG score 38 of Tier 3, which indicates that ESG criteria has been sufficiently designed and is adequately documented for standardized use across the enterprise. The score can also indicate that there is a relatively clear understanding of ESG goals linked to business strategy and stakeholder expectations. The ESG scoring unit 94 can also generate an ESG score 38 of Tier 4, which indicates that integrated ESG criteria has been designed and are adequately documented, with real time monitoring being completed and continuous improvement efforts underway to refine the ESG framework. The ESG scores 38 can be conveyed to the reporting unit 34 to generate reports.

The ESG assessment unit 36 can thus be employed to lower the carbon output during the conception, design, and engineering phases of the project to identify opportunities for lowering carbon output or footprint. The system 10 can also be employed to support the enterprise by reviewing the roadmap for green procurement and the process from upstream material identification through downstream channels during the project.

The project planning and assessment system 10 can also employ one or more machine learning models that can be employed by one or more of the units of the system. The models can be trained on historical project data and appropriate data mapping can be performed. The project planning and assessment system 10 can also be configured to select an appropriate machine learning model that are compatible with the functions of one or more units of the system. The machine learning models can be trained and tested.

It is to be understood that although the present invention has been described above in terms of particular embodiments, the foregoing embodiments are provided as illustrative only, and do not limit or define the scope of the invention. Various other embodiments, including but not limited to those described herein are also within the scope of the claims. For example, elements, units, modules, engines, tools and components described herein may be further divided into additional components or joined together to form fewer components for performing the same functions.

Any of the functions disclosed herein may be implemented using means for performing those functions. Such means include, but are not limited to, any of the components, units or engines disclosed herein, such as the electronic or computing device components described herein.

The techniques described above and below may be implemented, for example, in hardware, one or more computer programs tangibly stored on one or more computer-readable media, firmware, or any combination thereof. The techniques described above may be implemented in one or more computer programs executing on (or executable by) a programmable computer or electronic device having any combination of any number of the following: a processor, a storage medium readable and/or writable by the processor (including, for example, volatile and non-volatile memory and/or storage elements), an input device, an output device, and a display. Program code can be applied to input entered using the input device to perform the functions described and to generate output using the output device.

The term computing device or electronic device as used herein can refer to any device that includes a processor and a computer-readable memory capable of storing computer-readable instructions, and in which the processor is capable of executing the computer-readable instructions in the memory. The terms computer system and computing system refer herein to a system containing one or more computing devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require a computer, an electronic device, a computing device, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements if such elements are recited. For example, any method claim herein which recites that the claimed method is performed by a computer, a processor, a memory, and/or similar computer-related element, is intended to encompass methods which are performed by the recited computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to generate scores associated with the specific portions of the project. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing or electronic device or within a distributes system employing multiple devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer or electronic device can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1. A computer-implemented system for assessing a project, comprising
a project readiness assessment unit for assessing a project readiness of a project based on source data from a plurality of data sources and for generating a project assessment score, wherein the source data includes project data and wherein the project data includes project cost data including project cost estimate data, project scope data, project risk data, and project control data,
a project diagnostic and cost assessment unit for receiving the project cost data including the project cost estimate data and for determining an accuracy of a cost associated with the project based on the project cost data and the project cost estimate data and for generating a project cost accuracy score,
a project schedule assessment unit for applying one or more schedule analysis and assessment techniques to the project schedule data to assess a quality and an accuracy of a project schedule and for generating a project schedule score,
a project risk assessment unit for processing the project risk data and for determining an inherent risk score associated with the project,
a project control assessment unit for receiving and processing the project control data and for generating a project control score, and
a reporting unit that can includes a user interface generator for generating one or more user interfaces for generating and displaying on a display device one or more reports.

2. The computer-implemented system of claim 1, wherein the project readiness assessment unit comprises
a categorization unit for categorizing the source data into a plurality of project categories, wherein each of the plurality of project categories includes a plurality of project subcategories, wherein the categorization unit generates category data, and
a project readiness scoring unit for receiving and processing the category data and for generating the project assessment score.

3. The computer-implemented system of claim 2, wherein the project readiness scoring unit generates the project assessment score by summing together a category assessment score generated for each of the plurality of project categories, and wherein each of the category assessment scores are determined by summing together a subcategory assessment score for each of the plurality of project subcategories associated with each of the plurality of project categories, and wherein the project assessment score is indicative of a readiness of the project to be undertaken.

4. The computer-implemented system of claim 3, wherein the plurality of project categories comprises one or more of a project characteristics category, a project execution strategy category, a basis of design category, and an operations category.

5. The computer-implemented system of claim 4, wherein the project characteristics category comprises a plurality of project subcategories including two or more of a project objective subcategory, a due diligence subcategory, a funding model subcategory, a schedule definition subcategory, and a development rights subcategory.

6. The computer-implemented system of claim 3, wherein the category scores for each of the plurality of project categories or the subcategory scores for each of the plurality of project subcategories are weighted relative to each other based on one or more project factors.

7. The computer-implemented system of claim 3, wherein the project assessment score associated with each of the plurality of project categories is compared with a corresponding threshold assessment score, and if the project assessment score is less than the threshold assessment score, perform one or more project related actions.

8. The computer-implemented system of claim 7, wherein the one or more project related actions comprises one or more of delaying or holding the project, recommend that additional project design work be performed to reduce uncertainty associated with the project, correct any identified project scheduling issues, adjust a budget associated with the project, and recommend the addition of one or more project resources.

9. The computer-implemented system of claim 6, wherein the project data includes stage data and gate data, wherein the project readiness assessment unit processes the stage data and the gate data to determine a progress of the project.

10. The computer-implemented system of claim 2, wherein the project diagnostic and cost assessment unit comprises
a cost classification unit for classifying the project cost data into one or more of a plurality of cost classifications, wherein each of the plurality of cost classifications includes a plurality of cost subclassifications, wherein the cost classification unit generates cost classification data, and
a project cost accuracy determination unit for determining, based on the cost classification data, a project cost accuracy score indicative of an accuracy of a cost associated with the project.

11. The computer-implemented system of claim 10, wherein the plurality of cost classifications comprises a process industry cost classification and a general building cost classification.

12. The computer-implemented system of claim 11, wherein the plurality of cost subclassifications comprise two or more of a project scope description subclassification, a plant production capacity subclassification, a plant location subclassification, a soil and hydrology subclassification, an integrated project plan subclassification, a project master schedule subclassification, an escalation strategy subclassification, a work breakdown structure subclassification, an escalation strategy subclassification, a project code of accounts subclassification, a contracting strategy subclassification, a diagrams subclassification, a plot plans subclassification, a process flow diagrams subclassification, a utility flow diagrams subclassification, an instrument diagrams subclassification, a heating material balances subclassification, a process equipment list subclassification, a utility equipment list subclassification, an electrical drawing subclassification, a specification and data sheet subclassification, a general equipment arrangement subclassification, a spare parts subclassification, a mechanical discipline drawings subclassification, an electrical discipline drawings subclassification, an instrumentation and control system subclassification, and a civil and structural site discipline subclassification.

13. The computer-implemented system of claim 12, wherein the general building cost classification comprises a plurality of cost subclassifications including two or more of an assessment area subclassification, a project general scope description subclassification, a project location subclassification, a building area subclassification, a functional space requirements subclassification, a building specific subclassification, an exterior closure description subclassification, a finishes description and requirements subclassification, a building code or standards requirement subclassification, a mechanical systems and total capacity subclassification, an electrical capacity subclassification, a communication system subclassification, a fire protection and life safety requirements subclassification, a security system subclassification, an antiterrorism force protection requirements subclassification, a LEED certification level subclassification, a soil and hydrology subclassification, an integrated project plan subclassification, a project master schedule subclassification, a work breakdown structure subclassification, a project code of accounts subclassification, a contracting strategy subclassification, an escalation strategy and basis subclassification, a building codes and standards subclassification, a site plan subclassification, a demolition plan and drawing subclassification, a utility plan and drawing subclassification, a site electrical plan and drawings subclassification, a site lighting plan and drawing subclassification, a site communications plan and drawing subclassification, an erosion control plan subclassification, a stormwater plan subclassification, a landscape plan subclassification drama and exterior elevations subclassification, an interior elevations subclassification, an interior section views subclassification, a partition or wall type subclassification, a fender schedule subclassification, a door schedule subclassification, a window schedule subclassification, a restroom schedule subclassification, a furniture plan subclassification, a signage subclassification, a fire protection plan subclassification, a room layout plan subclassification, a foundation plan subclassification, a foundation section subclassification, a structural plan subclassification, a roof plan subclassification, a building envelope subclassification, material and equipment subclassification, a mechanical and HVAC subclassification, a flow control subclassification, a plumbing subclassification, and electrical subclassification, a lighting subclassification, and an information systems and telecommunications subclassification.

14. The computer-implemented system of claim 10, wherein the cost accuracy determination unit generates the project cost accuracy score by summing together a classification score generated for each of the plurality of cost classifications, and wherein the classification scores are determined by summing together a subclassification score for each of the plurality of cost subclassifications associated with each of the plurality of classifications.

15. The computer-implemented system of claim 14, wherein the cost accuracy determination unit generates the project cost accuracy score by employing one or more project cost measurement techniques.

16. The computer-implemented system of claim 15, wherein the one or more project cost measurement techniques comprises one or more of a percentage deviation technique, a root mean square error (RMSE) technique, a mean absolute error (MAE) technique, and a standard deviation technique.

17. The computer-implemented system of claim 14, wherein the project cost accuracy determination unit generates the project cost accuracy score by employing one or more project cost comparative analysis techniques.

18. The computer-implemented system of claim 17, wherein the one or more project cost comparative analysis techniques comprise one or more of an analogous estimation technique, a bottom-up estimation technique, a three-point estimation technique, a parametric estimation technique, an expert judgment estimation technique, and a reserve analysis estimation technique.

19. The computer-implemented system of claim 10, wherein the project schedule assessment unit comprises
a project schedule assessment unit for applying the one or more schedule analysis and assessment techniques to the project schedule data to assess the quality and the accuracy of the project schedule and for generating project schedule assessment data, and
a project schedule scoring unit for determining the project schedule score based on one or more of the project schedule assessment data and a third party project schedule score.

20. The computer-implemented system of claim 19, wherein the schedule analysis and assessment technique analyzes the project schedule data and evaluates the quality and the accuracy of the project schedule data based on a set of predetermined project criteria.

21. The computer-implemented system of claim 20, wherein the project criteria comprises two or more of a project logic criteria, project lead criteria, project lag criteria, project relationship criteria, project hard restraint criteria, high float criteria, a negative float criteria, high duration task, invalid dates criteria, resources criteria, missed tasks criteria, critical path test criteria, a critical path length index (CPLI) criteria, and a baseline execution index (BEI).

22. The computer-implemented system of claim 20, wherein the project schedule scoring unit determines a project score for each of the predetermined project criteria, and the project schedule scoring unit determines a total project schedule score by summing together the project scores associated with each of the project criteria.

23. The computer-implemented system of claim 22, wherein each of the project scores associated with each of the project criteria are weighted differently relative to each other based on one or more predetermined project weighting factors.

24. The computer-implemented system of claim 19, wherein the project risk assessment unit comprises
a risk categorization unit for categorizing the project risk data into a plurality of project risk categories, wherein each of the plurality of project risk categories includes a plurality of project risk subcategories, wherein the categorization unit generates risk category data, and
a risk scoring unit for receiving and processing the risk category data and for generating the inherent risk score.

25. The computer-implemented system of claim 24, wherein the risk scoring unit determines the inherent risk score by summing together a category risk score generated for each of the plurality of project risk categories, and wherein the category risk scores are determined by summing together a subcategory risk score for each of the plurality of project risk subcategories associated with each of the plurality of project risk categories, and wherein the inherent risk score is determined by summing together the category risk scores.

26. The computer-implemented system of claim 25, wherein the risk scoring unit compares one or more of the category risk score, the subcategory risk score, or the inherent risk score with a threshold risk score, and if the risk score is above the threshold risk score, then the project risk assessment unit recommends a project risk action.

27. The computer-implemented system of claim 24, wherein the project control assessment unit comprises
a control categorization unit for categorizing the project control data into a plurality of project control categories, wherein each of the plurality of project control categories includes a plurality of project control subcategories, wherein the control categorization unit generates control category data, and
a control scoring unit for receiving and processing the control category data and for generating the project control score.

28. The computer-implemented system of claim 27, wherein the each of the plurality of project control subcategories has a plurality of assessment queries associated therewith.

29. The computer-implemented system of claim 1, wherein the reporting unit generates one or more reports based on the project assessment score, the project cost accuracy score, the project cost accuracy score, the project schedule score, the inherent risk score, and the project control score.

30. A computer-implemented method for assessing a project, comprising
assessing a project readiness with a project readiness assessment unit based on source data from a plurality of data sources and for generating a project assessment score, wherein the source data includes project data and wherein the project data includes project cost data including project cost estimate data, project scope data, project risk data, and project control data,
determining an accuracy of a cost associated with the project with a project diagnostic and cost assessment unit based on the project cost data and the project cost estimate data and generating in response a project cost accuracy score,
applying one or more schedule analysis and assessment techniques to the project schedule data with a project schedule assessment unit for assessing a quality of a project schedule and an accuracy of the project schedule and for generating a project schedule score,
determining an inherent risk score associated with the project with a project risk assessment unit based on the project risk data, and
assessing one or more project controls associated with the project with a project control assessment unit based on project control data and in response generating a project control score.

31. The computer-implemented method of claim 30, wherein the step of assessing a project comprises
categorizing the source data into a plurality of project categories, wherein each of the plurality of project categories includes a plurality of project subcategories and generating category data, and
generating the project assessment score based on the category data.

32. The computer-implemented method of claim 31, wherein the step of generating the project assessment score comprises summing together a category assessment score generated for each of the plurality of project categories, and wherein the category assessment scores are determined by summing together a subcategory assessment score for each of the plurality of project subcategories.

33. The computer-implemented method of claim 32, wherein the category assessment scores for each of the plurality of project categories or the subcategory assessment scores for each of the plurality of project subcategories are weighted relative to each other based on one or more project factors.

34. The computer-implemented method of claim 32, wherein the project assessment score associated with each of the plurality of project categories is compared with a corresponding threshold assessment score, and if the project assessment score is less than the threshold assessment score, perform one or more project related actions.

35. The computer-implemented method of claim 31, wherein the step of determining the accuracy of the cost associated with the project comprises
classifying the project cost data into a plurality of cost classifications, wherein each of the plurality of cost classifications includes a plurality of cost subclassifications, and then generating cost classification data, and
determining the accuracy of the cost associated with the project based on the cost classification data and generating in response the project cost accuracy score.

36. The computer-implemented method of claim 35, further comprising generating the project cost accuracy score by summing together a classification cost score generated for each of the plurality of cost classifications, and wherein the classification cost scores are determined by summing together a subclassification cost score for each of the plurality of cost subclassifications associated with each of the plurality of cost classifications.

37. The computer-implemented method of claim 36, further comprising generating the project cost accuracy score by applying one or more project cost measurement techniques to the cost classification data.

38. The computer-implemented method of claim 37, wherein the one or more project cost measurement techniques comprises one or more of a percentage deviation technique, a root mean square error (RMSE) technique, a mean absolute error (MAE) technique, and a standard deviation technique.

39. The computer-implemented method of claim 36, further comprising generating the project cost accuracy score by applying one or more project cost comparative analysis techniques to the cost classification data.

40. The computer-implemented method of claim 39, wherein the one or more project cost comparative analysis techniques comprise one or more of an analogous estimation technique, a bottom-up estimation technique, a three-point estimation technique, a parametric estimation technique, an expert judgment estimation technique, and a reserve analysis estimation technique.

41. The computer-implemented method of claim 35, wherein the step of assessing a quality of a project schedule comprises
applying the one or more schedule analysis and assessment techniques to the project schedule data and assessing the quality and the accuracy of the project schedule and generating project schedule assessment data, and
determining the project schedule score based on one or more of the project schedule assessment data and a third-party project schedule score.

42. The computer-implemented method of claim 41, wherein the schedule analysis and assessment technique analyzes the project schedule data and evaluates the quality and the accuracy of the project schedule data based on a set of predetermined project criteria.

43. The computer-implemented method of claim 42, wherein the project criteria comprises two or more of a project logic criteria, project lead criteria, project lag criteria, project relationship criteria, project hard restraint criteria, high float criteria, a negative float criteria, high duration task, invalid dates criteria, resources criteria, missed tasks criteria, critical path test criteria, a critical path length index (CPLI) criteria, and a baseline execution index (BEI).

44. The computer-implemented method of claim 42, further comprising determining a project score for each of the predetermined project criteria, and determining the project schedule score by summing together the project scores associated with each of the project criteria.

45. The computer-implemented method of claim 44, wherein each of the project scores associated with each of the project criteria are weighted differently relative to each other based on one or more predetermined project weighting factors.

46. The computer-implemented method of claim 41, further comprising
categorizing the project risk data into a plurality of project risk categories, wherein each of the plurality of project risk categories includes a plurality of project risk subcategories, and generating risk category data, and
receiving and processing the risk category data and generating the inherent risk score based thereon.

47. The computer-implemented method of claim 46, further comprising
determining the inherent risk score by summing together a category risk score generated for each of the plurality of project risk categories, and wherein the category risk scores are determined by summing together a subcategory risk score for each of the plurality of project risk subcategories associated with each of the plurality of project risk categories, and
determining the inherent risk score by summing together the category risk scores.

48. The computer-implemented method of claim 47, further comprising comparing one or more of the category risk score, the subcategory risk score, or the inherent risk score with a threshold risk score, and if the risk score is above the threshold risk score, then recommending a project risk action.

49. The computer-implemented method of claim 46, further comprising
categorizing the project control data into a plurality of project control categories, wherein each of the plurality of project control categories includes a plurality of project control subcategories, and generating control category data, and
receiving and processing the control category data and generating the project control score.

50. The computer-implemented method of claim 49, wherein the each of the plurality of project control subcategories has a plurality of assessment queries associated therewith.

51. The computer-implemented method of claim 49, further comprising
categorizing ESG data forming part of the project data into a plurality of ESG categories, wherein each of the plurality of ESG categories includes a plurality of ESG subcategories, and generating ESG category data, and
receiving and processing the ESG category data and generating an ESG control score indicative of a performance of the enterprise in attaining ESG related goals.
